(19) United States
(12) Patent Application Publication
(10) Pub. No.: US 2016/0077807 A1
(43) Pub. Date: Mar. 17, 2016

(54) CLOUD BASED SERVICE DESIGN INHERITANCE

(71) Applicant: HEWLETT-PACKARD DEVELOPMENT COMPANY, L.P., Houston, TX (US)

(72) Inventors: Matt Newman, Santa Cruz, CA (US); Steve Berube, Sandown, NH (US); Serdar Badem, Fort Collins, CO (US); Sandeep Kotagiri, Fort Collins, CO (US); Qingping Bian, Cupertino, CA (US); Lakshminarayana Mandaleeka, Santa Clara, CA (US)

(21) Appl. No.: 14/787,482

(22) PCT Filed: Jul. 31, 2013
(86) PCT No.: PCT/US2013/053067

§ 371 Date: Oct. 28, 2015

(51) Int. Cl. G06F 9/44; H04L 29/08

(52) U.S. Cl. CPC G06F 8/20; H04L 67/10

(57) ABSTRACT

Designing a cloud based service from a component palette can include providing a designer with a component palette. The component palette can include a plurality of component types each including an identification of the component type, a property defining the component type, and a relationship rule defining a relationship with another component type. The component palette can include a component template corresponding to a component type, comprising a specialized variant of the component type, wherein the component template inherits the property and the relationship rule of the component type. Designing can include receiving a request for a new component type from the designer, receiving an indication of one component type from which to derive the new component type, and deriving the new component type from the indicated one component type inheriting the property and the relationship rule from the indicated one of the plurality of component types.

### BACKGROUND

A cloud service generally refers to a service that allows end recipient computer systems (e.g., thin clients, portable computers, smartphones, desktop computers and so forth) to access a pool of hosted computing and/or storage resources (e.g., the cloud resources) and networks over a network (e.g., the Internet). In this manner, the host, a cloud service provider, may, as examples, provide Software as a Service (SaaS) by hosting applications; Infrastructure as Service (IaaS) by hosting equipment (e.g., servers, storage components, network components, etc.); or a Platform as a Service (PaaS) by hosting a computing platform (e.g., operating system, middleware, data bases, autoscaling infrastructure, etc.).

A typical cloud service incurs charges on a demand basis, is managed by the cloud service provider and may be scaled (e.g., scaled according to desired storage capacity, processing power, network bandwidth and so forth) by the end user. The cloud service may be a public service (e.g., an Internet-based service) that is generally available to all potential users or a limited access private service that is provided over a private network (e.g., a business enterprise network) as well as a managed cloud service—private or hosted—(e.g., a virtual private cloud service) or a hybrid cloud service (a cloud service that is a combination of the above). Traditionally, when a user orders a cloud service, the user may manually perform various actions related to deploying and configuring software associated with the ordered cloud service (e.g., deployment of virtual machines (VMs), middleware, application software, application components, and so forth) on the provisioned/instantiated infrastructure.

### BRIEF DESCRIPTION OF THE DRAWINGS

FIG. 1 is a diagram of an example of an environment for providing a service designer with a component palette for constructing a design of a cloud based service according to the present disclosure.

FIG. 2A illustrates a diagram of an example of a system for designing a cloud based service from a component palette according to the present disclosure.

FIG. 2B illustrates a diagram of an example of a computing device according to the present disclosure.

FIG. 3 illustrates a flow chart of an example of a method for designing a cloud based service from a component palette according to the present disclosure.

### DETAILED DESCRIPTION

A service manager can be used to offer and deliver (e.g., instantiate, provision, and deploy) services and manage the lifecycles of cloud services for end users. Managing the lifecycles of cloud services can include managing the building of a cloud service, ongoing management of an existing cloud service, reporting, metering, and/or auditing, for example. A cloud service manager can orchestrate the use of application programming interfaces (APIs) of existing cloud services for managing the lifecycles of the existing cloud services and combinations of the existing cloud services for users of end systems (e.g., desktops, portable computers, smartphones, clients, thin clients, servers).

Depending on the particular implementation, the selection and ordering of cloud lifecycle management services may be performed by a given service designer (e.g., an administrator) for a group of end subscribers (e.g., users of an enterprise), or the selection and ordering of the cloud capabilities may be performed by a given service designer (e.g., a user or employee) for the given service designer's individual use. Subscribers of the cloud service manager may select and order cloud capabilities through the cloud service manager. Cloud capabilities, as used herein, refer to existing cloud services, combinations of existing cloud services that are supported by existing cloud resources, as well as lifecycle management services that are offered and delivered by the service manager. The cloud capabilities may be associated with services that are associated with a “cloud”, which may be a public cloud (e.g., a cloud formed from an Internet-based network and which provides hosted cloud services that are generally available to members of the public), a private cloud (e.g., a cloud formed from a private, limited access network (such as an enterprise network) which provides hosted cloud services to a limited group of members), a virtual private cloud (e.g., a cloud formed from a public network providing hosted cloud services to a limited group of members), and/or a hybrid cloud (e.g., a cloud formed from a combination of two or more of the aforementioned clouds). Examples of clouds are not so limited, however, and a cloud may include a number of different types of, and/or combinations of, distributed computing systems. As used herein, “a” or “a number of” something can refer to one or more such things.

Some service managers enable service designers to generate cloud capabilities via service designer interaction (e.g., through a service designer portal or other interface). Such service managers utilize systems to instantiate a cloud capability, and may define optimum resources to perform a particular service.

A cloud service may begin its life as a service design created by a service designer using a service manager (e.g., a platform and/or console). A service design can contain a hierarchy of service components (e.g., the basic building blocks of a service design having the information, properties, actions, and/or relationship rules used to deploy a service).

A service designer may construct a service design by designing and configuring the hierarchy of service components. The service designer may rely on his particular expertise/skill level in creating and configuring the hierarchy of service components.

Constructing service designs in this manner may create varied design architecture amongst service designs. Further, reliance on the service designers' particular expertise/skill levels in creating and configuring the hierarchy of service components may fail to account for the skill void that exists between service designers.

In contrast, in accordance with various examples of the present disclosure, a service manager can provide a service designer with a palette of re-usable and standardized components from which to create a service design. A component palette of the various examples of the present disclosure can include a plurality of component types organizing and defining virtual components, physical components, and other components usable within a service design. The component palette can further include specialized component types referred to as component templates. The component template can inherit information, properties, actions, and/or relationship rules from the component type to which it corresponds. New component templates can be derived from the component template and can inherit the information, properties, actions, and/or relationship rules of the component template from which they are derived. Therefore, examples of the present disclosure can increase the standardization of service designs by providing service designers with re-usable components which inherit and share characteristics. This standardization can increase interoperability between service designs, cut down on repair times/costs by standardizing error correction, and can reduce costs associated with deploying and maintaining a large number of variants. Additionally, the reusability of the components provides for reduced development times, reduced concerns, and incremental development of components by developers with the highest level of expertise within a given component. That is, a service designer can utilize a component developed by a developer with a special expertise and/or skill in developing that component, where that service designer may not possess the same skill/expertise to develop that component. In this manner, mistakes in development of the components can be reduced and the service designer can avoid potential errors in his service design by utilizing the re-usable components with pre-validated information, properties, actions, and/or relationship rules.

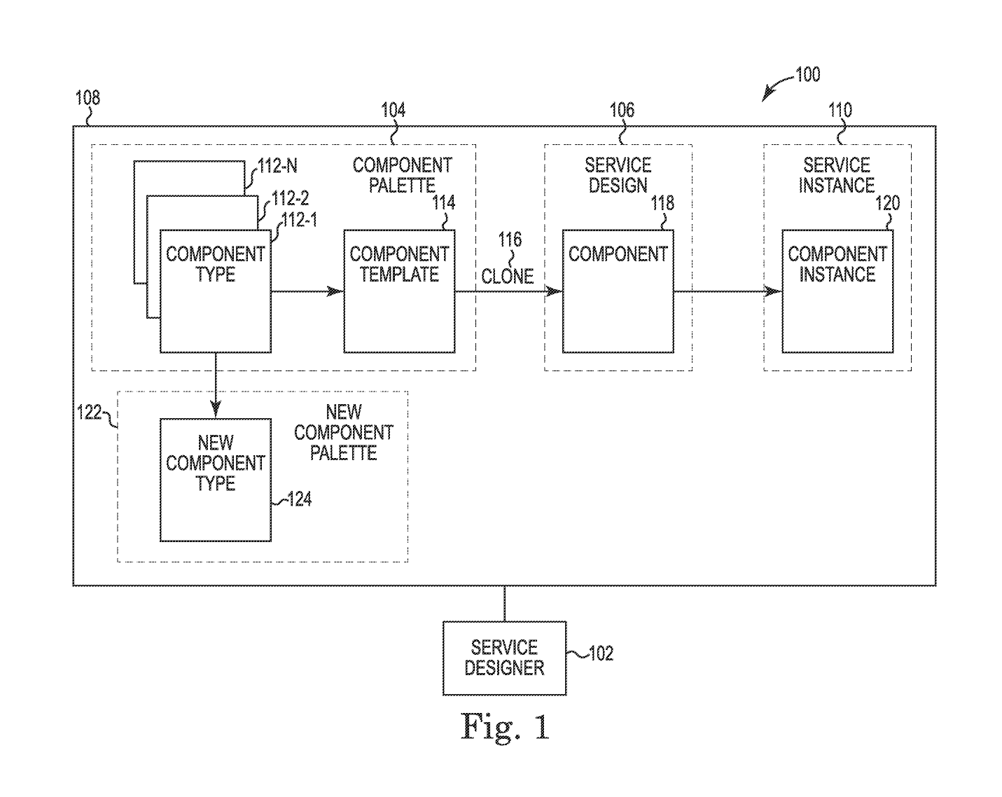

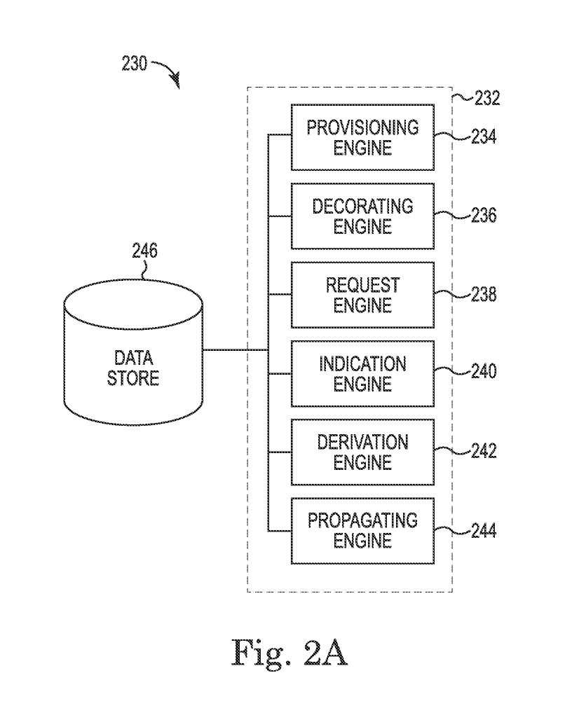

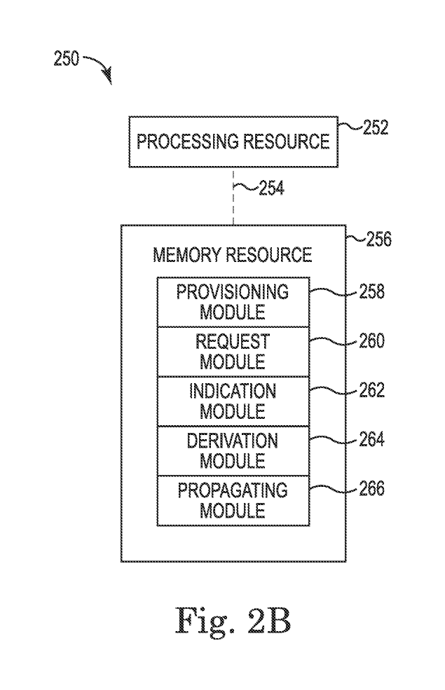

FIG. 1 is a diagram of an example of an environment 100 for providing a service designer 102 with a component palette 104 for constructing a service design 106 of a cloud based service according to the present disclosure. The environment 100 can include a service manager 108 configured to create a service design 106 for a cloud capability in collaboration with a service designer 102. The service manager 108 can include automation software that simplifies and automates the deployment of databases, middleware and packaged applications and enables composite application provisioning and monitoring in heterogeneous and extensible cloud computing environments. The service manager can be deployed on a computing device (e.g., a computing device as described in connection with FIG. 2B), for instance.

The service designer 102 can include a service designer 102 device. A service designer 102 device, as referred to herein, can be a computing device (e.g., a computing device as described in connection with FIG. 2B), for instance. The service designer 102 can include a service designer 102 portal to exchange inputs and outputs with the service manager 108. A service designer 102 portal, as referred to herein, can include a framework for integrating information, people, and/or processes through a unified access point (e.g., through a web-based user interface). In some examples, a service designer 102 portal can be accessed by a service designer 102 device.

The service manager 108 can be software on the service designer 102 device or the service manager 108 can be present on a separate device. In examples where the service manager 108 is present on a device separate from the service designer's 102 device, the service manager 108 may communicate with the service designer 102 device via a network. The network can include one or more of a local area network (LAN), a wide area network (WAN), and/or the Internet. Accordingly, the service manager 108 may reside on an Internet server, on a server within a private LAN, on a server within a WAN, on a desktop computer, and/or may be offered as Software as a Service (SaaS).

As shown in FIG. 1, the service designer 102 can utilize the service manager 108 in order to construct a service design 106 for implementation as a portion of a cloud-based service. The service manager 108 can provide the service designer 102 with a component palette 104 for constructing a service design 106 of a cloud based service. The component palette 104 can include a plurality of component types (112-1, 112-2, 112-N). Each component type (112-1, 112-2, 112-N) can specify the signature of the re-usable components available for utilization. The component type (112-1, 112-2, 112-N) can include, among other things, an identification of the component type (e.g., Server Group), a property defining the component type (e.g, hostname, IP address, etc.), and a relationship rule defining a relationship with another component type (e.g., hosted on server X).

The component palette 104 can additionally include a number of optional component templates 114. Each component template 114 can correspond to a component type (112-1, 112-2, 112-N). That is, a component template 114 can be an extension of a component type (112-1, 112-2, 112-N), wherein the component template 114 is a specialized version of a component type (112-1, 112-2, 112-N). The component template 114 can include properties and relationship rules from the corresponding component type (112-1, 112-2, 112-N) from which it was derived, additional and/or modified properties and relationship rules, and actions (e.g., deploy action on server) associated with the component template 114. It can be helpful to frame the relationship of the component template 114 corresponding component type (112-1, 112-2, 112-N) as parent-child, with the corresponding component type (112-1, 112-2, 112-N) as the parent and the component template 114 as the child. The properties and relationship rules from the parent corresponding component type (112-1, 112-2, 112-N) can be inherited by the child component template 114. While the child component template 114 inherits properties and relationship rules it can be further decorated with a set of standardized life cycle actions, have more information, have enriched definitions, have its own distinct actions, have its own distinct properties, and have its own distinct relationship rules.

The service designer 102 can select a component type (112-1, 112-2, 112-N) (e.g., Server Group, etc.) and a component template 114 (e.g., Web Server, Email Server, etc.) corresponding to the selected component type (112-1, 112-2, 112-N). The service designer 102 can then choose to clone 116 the component template 114 as a service design 106. The cloned component template 118 can inherit the properties, relationship rules, and actions of the component template 114 from which it was cloned which includes the properties and relationship rules inherited from the corresponding component type (112-1, 112-2, 112-N). The cloned component template 118 can then be modified as desired by the service designers. In some examples, the modification can be a modification to properties, relationship rules, and actions of the cloned component template 118. The modifications can be a modification selected form a list of modifications provided by the service manager 108. The list of modifications can be a list of pre-validated modifications available for the cloned component template 118. The pre-validated modifications can be modifications pre-validated based on the validity of identical or similar modifications with respect to the component template 114 from which the cloned component template 118 was cloned.

The cloned component template 118 can be instantiated into a component instance 120 of a service instance 110. The component instance 120 can inherit the properties, relationship rules, actions, etc. of the cloned component template 118 which includes of the properties, relationship rules, and actions of the component template 114 from which it was cloned and the properties and relationship rules inherited from the corresponding component type (112-1, 112-2, 112-N).

In an example of the present disclosure, the service designer 102 can create a new and/or unique component palette 122. For example, if a service designer frequently uses a particular component for which there is not a component type (112-1, 112-2, 112-N) available, and/or for which additional specialization to a component type (112-1, 112-2, 112-N) provides a more helpful starting point, the service designer 102 can create a new component palette 122 containing a new component type 124.

The service designer 102 can select an option to create a new component palette 122. The service designer 102 can select a component palette 104 from which to derive a new component type 124. For example, the service designer 102 can select a Server Group component type (112-1, 112-2, 112-N) to derive a Virtual Server new component type 124. When a new component type 124 is derived it can inherit the properties and relationship rules of the component type (112-1, 112-2, 112-N) from which it is derived.

In some examples of the present disclosure, the service designer 102 can select a component palette 104 from which to derive a new component type 124, a component type (112-1, 112-2, 112-N) associated with that component palette 104 from which to derive a new component type 124, and a component template 114 associated with that component type (112-1, 112-2, 112-N) from which to derive a new component type 124. The new component type 124 can inherit the properties, relationship rules, and actions of the selected component template 114 from which it was derived and the properties and relationship rules inherited from the corresponding component type (112-1, 112-2, 112-N) from which it was derived.

The new component palette 122 and the associated new component type 124 can be utilized in the same manner as discussed with component palette 104 and associated component types (112-1, 112-2, 112-N). The new component palette 122 can include new component templates (not shown) derived from the new component type 124 which can be cloned (not shown) into a new service design (not shown) and instantiated into a new component instance (not shown). Moreover, the new component type 124, new component templates, new cloned component templates, and the new component instances can inherit properties, relationship rules, and actions from the new component type 124, the new component template, the new clone component template, or the new component instance from which they were derived.

As described above, the new component palette 122 can be derived from a component palette 104 and/or its associated elements (e.g., component type (112-1, 112-2, 112-N), component template 114, etc.). Furthermore, the new component palette 122 can include associated elements (e.g., new component type 124, new component template, etc.) that can inherit properties, relationship rules, and actions from the elements from which they were derived. That is, inheritance of properties, relationship rules, and actions can span different component palettes (e.g., component palette 104 and new component palette 122).

The service manager 108 can receive modifications (e.g., create, update, delete) to properties, relationship rules, and actions of service manager elements (e.g., component types (112-1, 112-2, 112-N), component templates 114, cloned component templates 118, component instances 120, new component types 124, new component templates, new cloned component templates, and new component instances). When the service manager 108 receives a modification to a particular element (e.g., component type 112-1) it can propagate the modification to all the elements derived from that particular element (e.g., new component type 124, etc.). When labeled in terms of parent child as described above, the service manager 108 can receive modifications to a parent and propagate the modifications to a child, grandchild, great grandchild, etc.). Propagation of modifications in examples of the present disclosure can span across different component palettes (e.g., component palette 104 and new component palette 122).

FIGS. 2A-2B illustrate examples of systems 230, 250 according to the present disclosure. FIG. 2A illustrates a diagram of an example of a system 230 for designing a cloud based service from a component palette according to the present disclosure according to the present disclosure. The system 230 can include a data store 246, a management system 232, and/or a number of engines 234, 236, 238, 240, 242, 244. The management system 232 can be in communication with the data store 246 via a communication link, and can include the number of engines (e.g., provisioning engine 234, decorating engine 236, request engine 238, indication engine 240, derivation engine 242, propagating engine 244, etc.). The management system 232 can include additional or fewer engines than illustrated to perform the various functions described herein.

The number of engines can include a combination of hardware and programming that is configured to perform a number of functions described herein (e.g., provide the plurality of values to a user interface associated with the subscriber portal). The programming can include program instructions (e.g., software, firmware, etc.) stored in a memory resource (e.g., computer readable medium, machine readable medium, etc.) as well as hard-wired program (e.g., logic).

The provisioning engine 234 can include hardware and/or a combination of hardware and programming to provide a service designer with a component palette for constructing a design of a cloud based service. The component palette can include a plurality of component types. Each of the plurality of component types can be representative of a reusable component or components and can include the signature of the components being used. For example, the signature can include a property defining the component type, and a relationship rule defining a relationship with another component type. The component palette can include a component template corresponding to a component type associated with the component palette. The component template can include a specialized variant of the component type. The component template can inherit the property and relationship rules of the component type of which it is a specialized variant.

The decorating engine 236 can include hardware and/or a combination of hardware and programming to create a component template. Creation of a component template can be automated or can be a result of a service designer selection. The component template can be preconfigured within a service manager or can be based on historical component templates (e.g., pre-validated component templates from previous service designs). Component templates can be associated with a component palette and/or derived from a component type associated with a component palette. Creating a component template can include decorating a component type (e.g., a component type selected by a service designer) with a set of standardized life cycle actions. Decorating a component type can include specializing a component type by adding more information and enriching the definitions associated with the component type (e.g., adding a property specified by the service designer, adding an action specified by the service designer, adding a relationship rule specified by the service designer, modifying a property specified by the service designer, modifying an action specified by the service designer, modifying a relationship rule specified by the service designer, etc.). In decorating the component type, the service designer may specialize the selected component type by inputting original additions and/or modifications or the service designer may select additions and/or modifications from a menu of standardized additions and/or modifications (e.g., adding a standardized property specified by the service designer, adding a standardized action specified by the service designer, adding a standardized relationship rule specified by the service designer, modifying a property with a standardized property modification specified by the service designer, modifying an action with a standardized action modification specified by the service designer, modifying a relationship rule with a standardized relationship rule specified by the service designer, etc.). A standardized addition and/or modification can be an addition and/or modification which is pre-validated by the service manager, wherein the pre-validation can be based on the standardized addition and/or modification being on a pre-validated package with the service manager, and/or can be based on the standardized addition and/or modification being validated through historical data demonstrating the addition and/or modification will produce a valid component template. Standardized additions and/or modifications can be standardized across all component palettes, component templates, cloned component templates and component instances. Importantly, the component template can inherit the properties and relationship rules associated with the component type of which it is a specialized version. Component templates can be optional and are not necessary to every component type.

The request engine 238 can include hardware and/or a combination of hardware and programming to receive a request for a new component type from the service designer. A service designer can extend the functionality of a service manager via extending a component palette through addition of a new component type. Additionally, a service designer can extend the functionality of the service manager by creating a new component palette. The new component palette can be associated with a new component type and a new component template optionally associated with each new component palette. A service designer can initiate addition of a new component type associated with a new component palette and/or the addition of a new component type associated with an existing component palette by requesting a new component type from the service manager.

The indication engine 240 can include hardware and/or a combination of hardware and programming to receive an indication of one of the plurality of component types from which to derive the new component type. A service designer can indicate which of the component types from which he wishes to derive a new component type associated with a new component palette and/or a new component type associated with an existing component palette.

The derivation engine 242 can include hardware and/or a combination of hardware and programming to derive the new component type from the indicated one of the plurality of component types. The new component type can inherit the properties and the relationship rules from the indicated one of the plurality of component types (e.g., the component type from which it was derived). For example, the new component type Virtual Server can inherit the properties and the relationship rules from the Server Group component type from which it was derived.

The propagating engine 244 can include hardware and/or a combination of hardware and programming to receive a modification of the property of the indicated one of the plurality of component types by the designer and propagate the modification to the new component palette. A modification (e.g., create, update, delete) to a property, relationship rule, etc. of a component type can have can have implications for new component types and/or component templates derived therefrom. Therefore, the propagating engine 244 can include hardware and/or a combination of hardware and programming to receive a modification of the property of the indicated one of the plurality of component types by the designer and propagate the modification to any new component type, component template, cloned component template, and/or component instance derived therefrom across all component palettes.

FIG. 2B illustrates a diagram of an example of a computing device 250 according to the present disclosure. The computing device 250 can utilize software, hardware, firmware, and/or logic to perform a number of functions herein.

The computing device 250 can be any combination of hardware and program instructions configured to share information. The hardware for example can include a processing resource 252 and/or a memory resource 256 (e.g., computer-readable medium (CRM), machine readable medium (MRM), database, etc.) A processing resource 252, as used herein, can include any number of processors capable of executing instructions stored by a memory resource 256. Processing resource 252 may be integrated in a single device or distributed across multiple devices. The program instructions (e.g., computer-readable instructions (CRI)) can include instructions stored on the memory resource 256 and executable by the processing resource 252 to implement a desired function (e.g., to define a number of rules based on a number of parameter values).

The memory resource 256 can be in communication with a processing resource 252. A memory resource 256, as used herein, can include any number of memory components capable of storing instructions that can be executed by processing resource 252. Such memory resource 256 can be a non-transitory CRM or MRM. Memory resource 256 may be integrated in a single device or distributed across multiple devices. Further, memory resource 256 may be fully or partially integrated in the same device as processing resource 252 or it may be separate but accessible to that device and processing resource 252. Thus, it is noted that the computing device 250 may be implemented on a participant device, on a server device, on a collection of server devices, and/or a combination of the user device and the server device.

The memory resource 256 can be in communication with the processing resource 252 via a communication link (e.g., a path) 254. The communication link 254 can be local or remote to a machine (e.g., a computing device) associated with the processing resource 252. Examples of a local communication link 254 can include an electronic bus internal to a machine (e.g., a computing device) where the memory resource 256 is one of volatile, non-volatile, fixed, and/or removable storage medium in communication with the processing resource 252 via the electronic bus.

A number of modules 258, 260, 262, 264, 266 can include CRI that when executed by the processing resource 252 can perform a number of functions. The number of modules 258, 260, 262, 264, 266 can be sub-modules of other modules. For example, the provisioning module 258 and the request module 260 can be sub-modules and/or contained within the same computing device. In another example, the number of modules 258, 260, 262, 264, 266 can comprise individual modules at separate and distinct locations (e.g., CRM, etc.).

Each of the number of modules 258, 260, 262, 264, 266 can include instructions that when executed by the processing resource 252 can function as a corresponding engine as described herein. For example, the provisioning module 258 can include instructions that when executed by the processing resource 252 can function as the provisioning engine 234. In another example, request module 260 can include instructions that when executed by the processing resource 254 can function as the request engine 238.

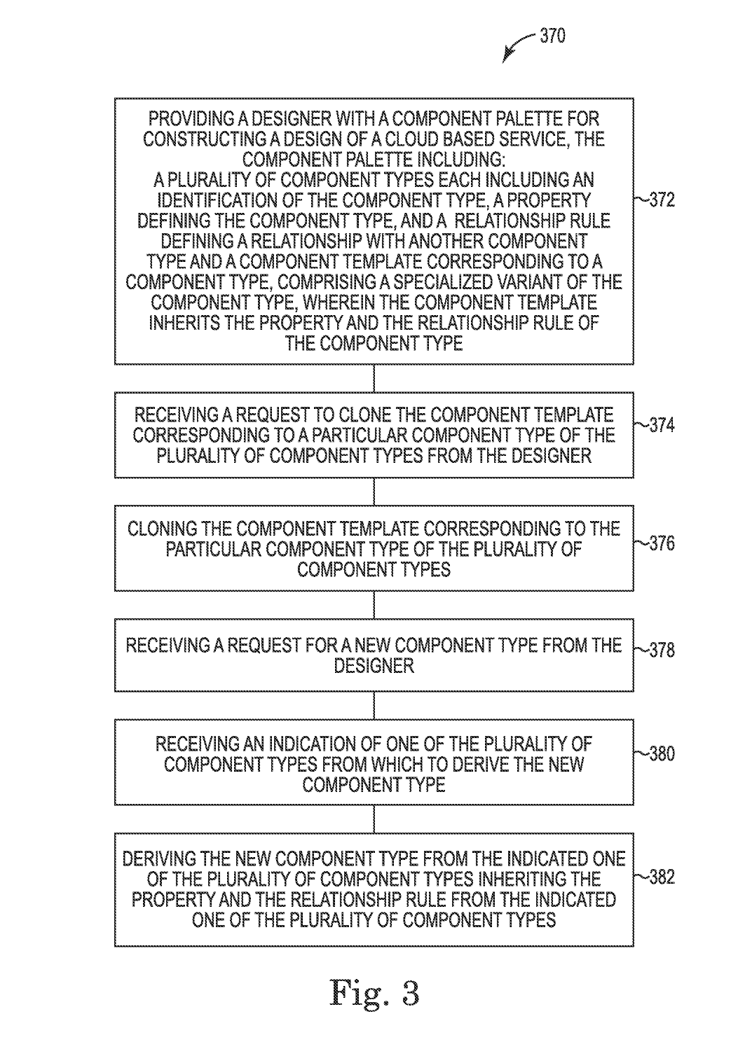

FIG. 3 illustrates a flow chart of an example of a method 370 for designing a cloud based service from a component palette according to the present disclosure. At 372, the method 370 can include providing a service designer with a component palette for constructing a design of a cloud based service. The component palette can include a plurality of component types each including an identification of the component type, a property defining the component type, and a relationship rule (e.g., a rule specifying that the component type is hosted on a particular server) defining a relationship with another component type. The component palette can also include a component template corresponding to a component type, comprising a specialized variant of the component type, wherein the component template inherits the property and the relationship rule of the component type.

At 374, the method 370 can include receiving a request to clone the component template corresponding to a particular component type of the plurality of component types from the service designer. For example, a service designer may request to clone a component template (e.g., Email Server, Web Server, etc.) associated with a component type (e.g., server group) for service design use. The service designer may then request to clone the component template.

At 376, the method 370 can include cloning the component template corresponding to the particular component type of the plurality of component types. Cloning the component template corresponding to the particular component type can include creating a cloned component template for use in a service design. The cloned component template can inherit the properties, actions, and relationship rules of the component template from which it was derived and the component type associated with the component template from which it was derived.

The service manager can also receive modifications (e.g., create, update, delete, etc.) to the properties, actions, and relationship rules of the cloned component template from the service designer. The service designer can customize the cloned component template to fit within the cloud-based service design. The service designer can input modifications to the service manager. The service designer can additionally or alternatively select modifications to the cloned component template from a menu of standardized modifications. The menu of standardized modifications can include pre-validated modifications. The pre-validated modifications can be modifications pre-validated based on the validity of identical or similar modifications with respect to the component template from which the cloned component template was cloned.

The cloned component template (modified or unmodified) can be instantiated into a component instance of a service instance. The component instance can inherit the properties, relationship rules, actions, etc. of the cloned component template which includes of the properties, relationship rules, and actions of the component template from which it was cloned and the properties and relationship rules inherited from the corresponding component type.

At 378, the method 370 can include receiving a request for a new component type from the service designer. The request can be a request for a new component type to be associated with an existing component palette. Alternatively or additionally, the request can be a request for a new component type to be associated with a new component palette. Therefore, the request can include a request to create a new component palette.

At 380, the method 370 can include receiving an indication of one of the plurality of component types from which to derive the new component type. The service designer can send an indication to the service manager of which component type to derive the new component type from. The service designer may select the component type to derive the new component type from based on the properties, relationship rules, etc. that the cloud-based service design will utilize.

At 382, the method 370 can include deriving the new component type from the indicated one of the plurality of component types inheriting the property and the relationship rule from the indicated one of the plurality of component types. The derived new component type can inherit the information, properties, actions, and/or relationship rules of the component type from which it is derived.

In the detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

In addition, the proportion and the relative scale of the elements provided in the figures are intended to illustrate the examples of the present disclosure, and should not be taken in a limiting sense. As used herein, the designator “N”, particularly with respect to reference numerals in the drawings, indicate that a number of the particular feature so designated can be included with a number of examples of the present disclosure.

What is claimed:

1. A non-transitory computer-readable medium storing a set of instructions executable by a processing resource to:
provide a designer with a component palette for constructing a design of a cloud based service, the component palette including:
a plurality of component types each including an identification of the component type, a property defining the component type, and a relationship rule defining a relationship with another component type; and
a component template corresponding to a component type, comprising a specialized variant of the component type, wherein the component template inherits the property and the relationship rule of the component type;
receive a request for a new component type from the designer;
receive an indication of one of the plurality of component types from which to derive the new component type; and
derive the new component type from the indicated one of the plurality of component types inheriting the property and the relationship rule from the indicated one of the plurality of component types.

2. The medium of claim 1, including instructions executable to receive a modification of the property of the indicated one of the plurality of component types from the designer and propagating the modification to the new component.

3. The medium of claim 1, wherein the component type comprises a server group, the component template comprises a web server, and the new component type comprises a virtual server.

4. The medium of claim 1, wherein the component template includes an additional property to the property inherited from the corresponding component type.

5. The medium of claim 4, wherein the component template includes a life cycle action not present in the corresponding component type.

6. The medium of claim 1, wherein the component template includes a modification to the property inherited from the corresponding component type.

7. A system for designing a cloud based service from a component palette, comprising a processing resource in communication with a non-transitory computer-readable medium having instructions executable by the processing resource to implement a provisioning engine, a decorating engine, a request engine, an indication engine, and a derivation engine, wherein:
the provisioning engine provides a designer with a component palette for constructing a design of a cloud based service, the component palette including:
a plurality of component types each including an identification of the component type, a property defining the component type, and a relationship rule defining a relationship with another component type;
the decorating engine creates a component template, by addition of a standardized property and a standardized action specified by the designer to a one of the plurality of component types selected by the designer, wherein the component template inherits the property and the relationship rule of the one of the plurality of component types selected by the designer;
the request engine receives a request for a new component type from the designer;
the indication engine receives an indication of one of the plurality of component types from which to derive the new component type; and
the derivation engine derives the new component type from the indicated one of the plurality of component types inheriting the property and the relationship rule from the indicated one of the plurality of component types.

8. The system of claim 7, wherein creating a component template includes associating the one of the plurality of component types selected by the designer with a standardized relationship rule specified by the designer.

9. The system of claim 7, wherein the new component type is associated with a new component palette.

10. The system of claim 9, wherein the propagating engine receives a modification of the property of the indicated one of the plurality of component types by the designer and propagates the modification to the hew component palette.

11. The system of claim 10, wherein the modification includes at least one of changing the property by updating the property, changing the property by deleting the property, and creating a new property.

12. A method for designing a cloud based service from a component palette, the method comprising:
providing a designer with a component palette for constructing a design of a cloud based service, the component palette including:
a plurality of component types each including an identification of the component type, a property defining the component type, and a relationship rule defining a relationship with another component type; and
a component template corresponding to a component type, comprising a specialized variant of the component type, wherein the component template inherits the property and the relationship rule of the component type;
receiving a request to clone the component template corresponding to a particular component type of the plurality of component types from the designer;
cloning the component template corresponding to the particular component type of the plurality of component types;
receiving a request for a new component type from the designer;
receiving an indication of one of the plurality of component types from which to derive the new component type; and
deriving the new component type from the indicated one of the plurality of component types inheriting the property and the relationship rule from the indicated one of the plurality of component types.

13. The method of claim 12, including receiving modifications to a property and an action of the clone of the component template.

14. The method of claim 13, including instantiating the clone of the component template.

15. The method of claim 14, wherein the instantiated clone inherits the property and relationship rule of the component template from which it was cloned.
